(19) United States
(12) Patent Application Publication
(10) Pub. No.: US 2025/0112498 A1
(43) Pub. Date: Apr. 3, 2025

(54) CONDUCTIVE CHARGING PADS FOR WEARABLE DEVICE CHARGER

(71) Applicant: Oura Health Oy, Oulu (FI)

(72) Inventors: Antti Pekka Saikkonen, Haukipudas (FI); Kent Krister Sippola, Oulu (FI)

(21) Appl. No.: 18/478,075

(22) Filed: Sep. 29, 2023

(51) Int. Cl. H02J 50/10; H02J 7/00; H02J 50/40; H02J 50/90

(52) U.S. Cl. CPC H02J 50/10; H02J 7/0044; H02J 50/40; H02J 50/90

(57) ABSTRACT

A charging device for a wearable device is described. The charging device may include a charger housing corresponding to a size of the wearable device and a charger assembly within the charger housing. The charger assembly may include an inductive charging component, one or more inductive pads, and a printed circuit board (PCB). The inductive charging component may be configured to wirelessly interface with an additional inductive charging component of the wearable device to charge the wearable device through the charger housing. The conductive pads may be electrically coupled with the inductive charging component. The PCB may be configured to electrically couple the charger assembly to an external power source, and may include an electrical contact component configured to electrically and physically contact the conductive pads at one of multiple locations along a length of the conductive pads based on the charger size.

### FIELD OF TECHNOLOGY

The following relates to wearable devices and data processing, including conductive charging pads for a wearable device charger.

### BACKGROUND

Some wearable devices may be configured to collect data from users associated with biological data, including temperature data, heart rate data, and the like. The wearable devices may be configured to charge on a charger base. Various sizes of wearable devices may be associated with various sizes of chargers, thereby increasing the discrete quantity of charger devices that must be manufactured.

### BRIEF DESCRIPTION OF THE DRAWINGS

FIG. 1 illustrates an example of a system that supports a wearable device charger in accordance with aspects of the present disclosure.

FIG. 2 illustrates an example of a system that supports conductive charging pads for a wearable device charger in accordance with aspects of the present disclosure.

FIG. 3 shows an example of a charging device diagram that supports a wearable device charger in accordance with aspects of the present disclosure.

FIG. 4 shows an example of a charging device diagram that supports a wearable device charger in accordance with aspects of the present disclosure.

FIG. 5 shows an example of a charging device diagram that supports a wearable device charger in accordance with aspects of the present disclosure.

FIG. 6 shows an example of a charging device diagram that supports a wearable device charger in accordance with aspects of the present disclosure.

### DETAILED DESCRIPTION

Wearable devices, such as wearable ring devices, may be configured to collect physiological data from users, such as light-based photoplethysmogram (PPG) data. However, the level or quality of skin contact between the wearable device and the user's tissue may affect the quality of PPG measurements. As such, wearable devices, such as a wearable ring device, may be manufactured in varying sizes in order to achieve good skin contact (and comfortable fit) for different users, and to cover respective variations in user fit. For example, wearable ring devices may be manufactured in multiple discrete sizes to accommodate a wide range of user finger sizes. In some cases, a wearable device may come with a charger manufactured for the size of the respective wearable device. In particular, wearable devices may charge via inductive charging, where chargers may be specifically sized to fit certain sized rings to ensure sufficient contact between the charger device and wearable device to facilitate inductive charging. Thus, different sized wearable ring devices may require different sized chargers for sufficient charging contact. Requiring multiple different sized chargers increases the manufacturing cost of the charger devices, and therefore increases the cost of the wearable ring devices.

Techniques described herein provide for components of a charger device that may be implemented across charger devices of varying sizes. The charger device may include a charger assembly that is manufactured in a single size for a wide range of charger sizes. That is, the “charger assembly” may be manufactured in a single size, where the “charger assembly” may be used across a wide array of different sized charger devices. The charger assembly includes an inductive charging component and conductive charging pads that extend a length of the charger assembly, where an electrical contact component of a circuit board may contact the conductive charging pads at any point along the charging pads to electrically couple the circuit board to the inductive charging component.

The position of the charger assembly within the charger device may vary depending on the size of the charger device. For example, for smaller charger devices, the charger assembly may be moved closer to the center of the charger device, where the electrical contact component may contact the conductive charging pads toward an end of the conductive charging pads closer to the inductive charging component. Comparatively, for larger charger devices, the charger assembly may be moved further from the center of the charger device, where the electrical contact component may contact the conductive charging pads toward an opposite end of the conductive charging pads further from the inductive charging component. The use of a single-sized charger assembly may reduce manufacturing costs of the charger device, and therefore reduce the cost of the corresponding wearable devices. Moreover, the conductive charging pads of the charger assembly may enable the single-sized charger assembly to fit within a wide array of charger devices, and may simplify the process of connecting the circuit board to the charger device.

Aspects of the disclosure are initially described in the context of systems supporting physiological data collection from users via wearable devices. Aspects of the disclosure are further illustrated by and described with reference to charging device diagrams that relate to conductive charging pads for a wearable device charger.

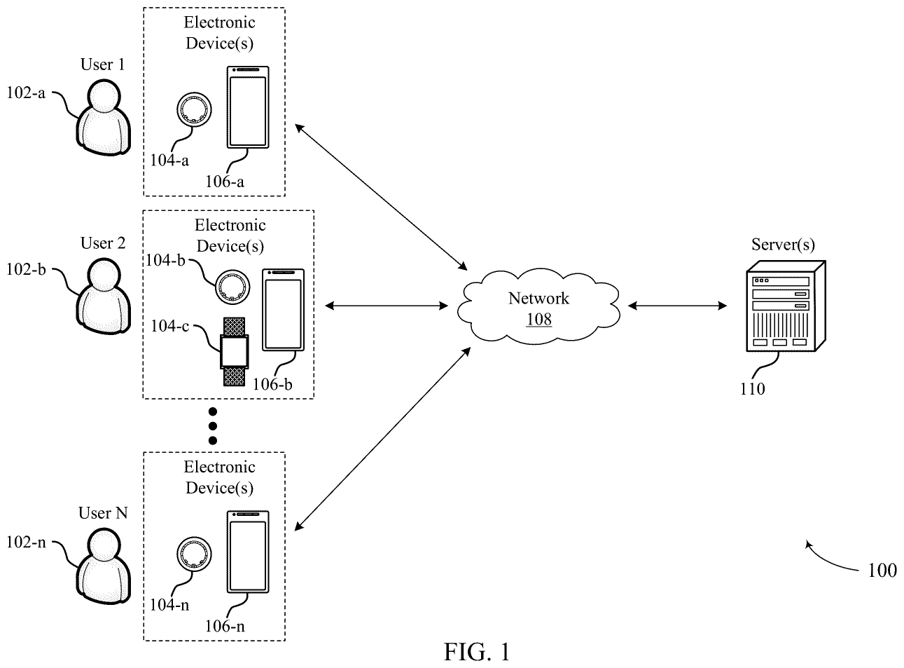

FIG. 1 illustrates an example of a system 100 that supports a wearable device charger in accordance with aspects of the present disclosure. The system 100 includes a plurality of electronic devices (e.g., wearable devices 104, user devices 106) that may be worn and/or operated by one or more users 102. The system 100 further includes a network 108 and one or more servers 110.

The electronic devices may include any electronic devices known in the art, including wearable devices 104 (e.g., ring wearable devices, watch wearable devices, etc.), user devices 106 (e.g., smartphones, laptops, tablets). The electronic devices associated with the respective users 102 may include one or more of the following functionalities: 1) measuring physiological data, 2) storing the measured data, 3) processing the data, 4) providing outputs (e.g., via GUIs) to a user 102 based on the processed data, and 5) communicating data with one another and/or other computing devices. Different electronic devices may perform one or more of the functionalities.

Example wearable devices 104 may include wearable computing devices, such as a ring computing device (hereinafter “ring”) configured to be worn on a user's 102 finger, a wrist computing device (e.g., a smart watch, fitness band, or bracelet) configured to be worn on a user's 102 wrist, and/or a head mounted computing device (e.g., glasses/goggles). Wearable devices 104 may also include bands, straps (e.g., flexible or inflexible bands or straps), stick-on sensors, and the like, that may be positioned in other locations, such as bands around the head (e.g., a forehead headband), arm (e.g., a forearm band and/or bicep band), and/or leg (e.g., a thigh or calf band), behind the ear, under the armpit, and the like. Wearable devices 104 may also be attached to, or included in, articles of clothing. For example, wearable devices 104 may be included in pockets and/or pouches on clothing. As another example, wearable device 104 may be clipped and/or pinned to clothing, or may otherwise be maintained within the vicinity of the user 102. Example articles of clothing may include, but are not limited to, hats, shirts, gloves, pants, socks, outerwear (e.g., jackets), and undergarments. In some implementations, wearable devices 104 may be included with other types of devices such as training/sporting devices that are used during physical activity. For example, wearable devices 104 may be attached to, or included in, a bicycle, skis, a tennis racket, a golf club, and/or training weights.

Much of the present disclosure may be described in the context of a ring wearable device 104. Accordingly, the terms “ring 104,” “wearable device 104,” and like terms, may be used interchangeably, unless noted otherwise herein. However, the use of the term “ring 104” is not to be regarded as limiting, as it is contemplated herein that aspects of the present disclosure may be performed using other wearable devices (e.g., watch wearable devices, necklace wearable device, bracelet wearable devices, earring wearable devices, anklet wearable devices, and the like).

In some aspects, user devices 106 may include handheld mobile computing devices, such as smartphones and tablet computing devices. User devices 106 may also include personal computers, such as laptop and desktop computing devices. Other example user devices 106 may include server computing devices that may communicate with other electronic devices (e.g., via the Internet). In some implementations, computing devices may include medical devices, such as external wearable computing devices (e.g., Holter monitors). Medical devices may also include implantable medical devices, such as pacemakers and cardioverter defibrillators. Other example user devices 106 may include home computing devices, such as internet of things (IoT) devices (e.g., IoT devices), smart televisions, smart speakers, smart displays (e.g., video call displays), hubs (e.g., wireless communication hubs), security systems, smart appliances (e.g., thermostats and refrigerators), and fitness equipment.

Some electronic devices (e.g., wearable devices 104, user devices 106) may measure physiological parameters of respective users 102, such as photoplethysmography waveforms, continuous skin temperature, a pulse waveform, respiration rate, heart rate, heart rate variability (HRV), actigraphy, galvanic skin response, pulse oximetry, blood oxygen saturation (SpO2), blood sugar levels (e.g., glucose metrics), and/or other physiological parameters. Some electronic devices that measure physiological parameters may also perform some/all of the calculations described herein. Some electronic devices may not measure physiological parameters, but may perform some/all of the calculations described herein. For example, a ring (e.g., wearable device 104), mobile device application, or a server computing device may process received physiological data that was measured by other devices.

In some implementations, a user 102 may operate, or may be associated with, multiple electronic devices, some of which may measure physiological parameters and some of which may process the measured physiological parameters. In some implementations, a user 102 may have a ring (e.g., wearable device 104) that measures physiological parameters. The user 102 may also have, or be associated with, a user device 106 (e.g., mobile device, smartphone), where the wearable device 104 and the user device 106 are communicatively coupled to one another. In some cases, the user device 106 may receive data from the wearable device 104 and perform some/all of the calculations described herein. In some implementations, the user device 106 may also measure physiological parameters described herein, such as motion/activity parameters.

For example, as illustrated in FIG. 1, a first user 102-a (User 1) may operate, or may be associated with, a wearable device 104-a (e.g., ring 104-a) and a user device 106-a that may operate as described herein. In this example, the user device 106-a associated with user 102-a may process/store physiological parameters measured by the ring 104-a. Comparatively, a second user 102-b (User 2) may be associated with a ring 104-b, a watch wearable device 104-c (e.g., watch 104-c), and a user device 106-b, where the user device 106-b associated with user 102-b may process/store physiological parameters measured by the ring 104-b and/or the watch 104-c. Moreover, an nth user 102-n (User N) may be associated with an arrangement of electronic devices described herein (e.g., ring 104-n, user device 106-n). In some aspects, wearable devices 104 (e.g., rings 104, watches 104) and other electronic devices may be communicatively coupled to the user devices 106 of the respective users 102 via Bluetooth, Wi-Fi, and other wireless protocols.

In some implementations, the rings 104 (e.g., wearable devices 104) of the system 100 may be configured to collect physiological data from the respective users 102 based on arterial blood flow within the user's finger. In particular, a ring 104 may utilize one or more light-emitting components, such as LEDs (e.g., red LEDs, green LEDs) that emit light on the palm-side of a user's finger to collect physiological data based on arterial blood flow within the user's finger. In general, the terms light-emitting components, light-emitting elements, and like terms, may include, but are not limited to, LEDs, micro LEDs, mini LEDs, laser diodes (LDs) (e.g., vertical cavity surface-emitting lasers (VCSELs), and the like.

In some cases, the system 100 may be configured to collect physiological data from the respective users 102 based on blood flow diffused into a microvascular bed of skin with capillaries and arterioles. For example, the system 100 may collect PPG data based on a measured amount of blood diffused into the microvascular system of capillaries and arterioles. In some implementations, the ring 104 may acquire the physiological data using a combination of both green and red LEDs. The physiological data may include any physiological data known in the art including, but not limited to, temperature data, accelerometer data (e.g., movement/motion data), heart rate data, HRV data, blood oxygen level data, or any combination thereof.

The use of both green and red LEDs may provide several advantages over other solutions, as red and green LEDs have been found to have their own distinct advantages when acquiring physiological data under different conditions (e.g., light/dark, active/inactive) and via different parts of the body, and the like. For example, green LEDs have been found to exhibit better performance during exercise. Moreover, using multiple LEDs (e.g., green and red LEDs) distributed around the ring 104 has been found to exhibit superior performance as compared to wearable devices that utilize LEDs that are positioned close to one another, such as within a watch wearable device. Furthermore, the blood vessels in the finger (e.g., arteries, capillaries) are more accessible via LEDs as compared to blood vessels in the wrist. In particular, arteries in the wrist are positioned on the bottom of the wrist (e.g., palm-side of the wrist), meaning only capillaries are accessible on the top of the wrist (e.g., back of hand side of the wrist), where wearable watch devices and similar devices are typically worn. As such, utilizing LEDs and other sensors within a ring 104 has been found to exhibit superior performance as compared to wearable devices worn on the wrist, as the ring 104 may have greater access to arteries (as compared to capillaries), thereby resulting in stronger signals and more valuable physiological data.

The electronic devices of the system 100 (e.g., user devices 106, wearable devices 104) may be communicatively coupled to one or more servers 110 via wired or wireless communication protocols. For example, as shown in FIG. 1, the electronic devices (e.g., user devices 106) may be communicatively coupled to one or more servers 110 via a network 108. The network 108 may implement transfer control protocol and internet protocol (TCP/IP), such as the Internet, or may implement other network 108 protocols. Network connections between the network 108 and the respective electronic devices may facilitate transport of data via email, web, text messages, mail, or any other appropriate form of interaction within a computer network 108. For example, in some implementations, the ring 104-a associated with the first user 102-a may be communicatively coupled to the user device 106-a, where the user device 106-a is communicatively coupled to the servers 110 via the network 108. In additional or alternative cases, wearable devices 104 (e.g., rings 104, watches 104) may be directly communicatively coupled to the network 108.

The system 100 may offer an on-demand database service between the user devices 106 and the one or more servers 110. In some cases, the servers 110 may receive data from the user devices 106 via the network 108, and may store and analyze the data. Similarly, the servers 110 may provide data to the user devices 106 via the network 108. In some cases, the servers 110 may be located at one or more data centers. The servers 110 may be used for data storage, management, and processing. In some implementations, the servers 110 may provide a web-based interface to the user device 106 via web browsers.

In some aspects, the system 100 may detect periods of time that a user 102 is asleep, and classify periods of time that the user 102 is asleep into one or more sleep stages (e.g., sleep stage classification). For example, as shown in FIG. 1, User 102-a may be associated with a wearable device 104-a (e.g., ring 104-a) and a user device 106-a. In this example, the ring 104-a may collect physiological data associated with the user 102-a, including temperature, heart rate, HRV, respiratory rate, and the like. In some aspects, data collected by the ring 104-a may be input to a machine learning classifier, where the machine learning classifier is configured to determine periods of time that the user 102-a is (or was) asleep. Moreover, the machine learning classifier may be configured to classify periods of time into different sleep stages, including an awake sleep stage, a rapid eye movement (REM) sleep stage, a light sleep stage (non-REM (NREM)), and a deep sleep stage (NREM). In some aspects, the classified sleep stages may be displayed to the user 102-a via a GUI of the user device 106-a. Sleep stage classification may be used to provide feedback to a user 102-a regarding the user's sleeping patterns, such as recommended bedtimes, recommended wake-up times, and the like. Moreover, in some implementations, sleep stage classification techniques described herein may be used to calculate scores for the respective user, such as Sleep Scores, Readiness Scores, and the like.

In some aspects, the system 100 may utilize circadian rhythm-derived features to further improve physiological data collection, data processing procedures, and other techniques described herein. The term circadian rhythm may refer to a natural, internal process that regulates an individual's sleep-wake cycle, that repeats approximately every 24 hours. In this regard, techniques described herein may utilize circadian rhythm adjustment models to improve physiological data collection, analysis, and data processing. For example, a circadian rhythm adjustment model may be input into a machine learning classifier along with physiological data collected from the user 102-a via the wearable device 104-a. In this example, the circadian rhythm adjustment model may be configured to “weight,” or adjust, physiological data collected throughout a user's natural, approximately 24-hour circadian rhythm. In some implementations, the system may initially start with a “baseline” circadian rhythm adjustment model, and may modify the baseline model using physiological data collected from each user 102 to generate tailored, individualized circadian rhythm adjustment models that are specific to each respective user 102.

In some aspects, the system 100 may utilize other biological rhythms to further improve physiological data collection, analysis, and processing by phase of these other rhythms. For example, if a weekly rhythm is detected within an individual's baseline data, then the model may be configured to adjust “weights” of data by day of the week. Biological rhythms that may require adjustment to the model by this method include: 1) ultradian (faster than a day rhythms, including sleep cycles in a sleep state, and oscillations from less than an hour to several hours periodicity in the measured physiological variables during wake state; 2) circadian rhythms; 3) non-endogenous daily rhythms shown to be imposed on top of circadian rhythms, as in work schedules; 4) weekly rhythms, or other artificial time periodicities exogenously imposed (e.g., in a hypothetical culture with 12 day “weeks,” 12 day rhythms could be used); 5) multi-day ovarian rhythms in women and spermatogenesis rhythms in men; 6) lunar rhythms (relevant for individuals living with low or no artificial lights); and 7) seasonal rhythms.

The biological rhythms are not always stationary rhythms. For example, many women experience variability in ovarian cycle length across cycles, and ultradian rhythms are not expected to occur at exactly the same time or periodicity across days even within a user. As such, signal processing techniques sufficient to quantify the frequency composition while preserving temporal resolution of these rhythms in physiological data may be used to improve detection of these rhythms, to assign phase of each rhythm to each moment in time measured, and to thereby modify adjustment models and comparisons of time intervals. The biological rhythm-adjustment models and parameters can be added in linear or non-linear combinations as appropriate to more accurately capture the dynamic physiological baselines of an individual or group of individuals.

In some aspects, the respective devices of the system 100 may support a charger device (e.g., charging device) for charging the ring 104. The charger device may include a charger assembly that is manufactured in a single size for a wide range of charger sizes, and thus support a wide range of ring 104 sizes. The charger assembly includes an inductive charging component, conductive charging pads that extend a length of the charger assembly, and other additional components. An electrical contact component of a circuit board may contact the conductive charging pads at any point along the charging pads to electrically couple the circuit board to the inductive charging component.

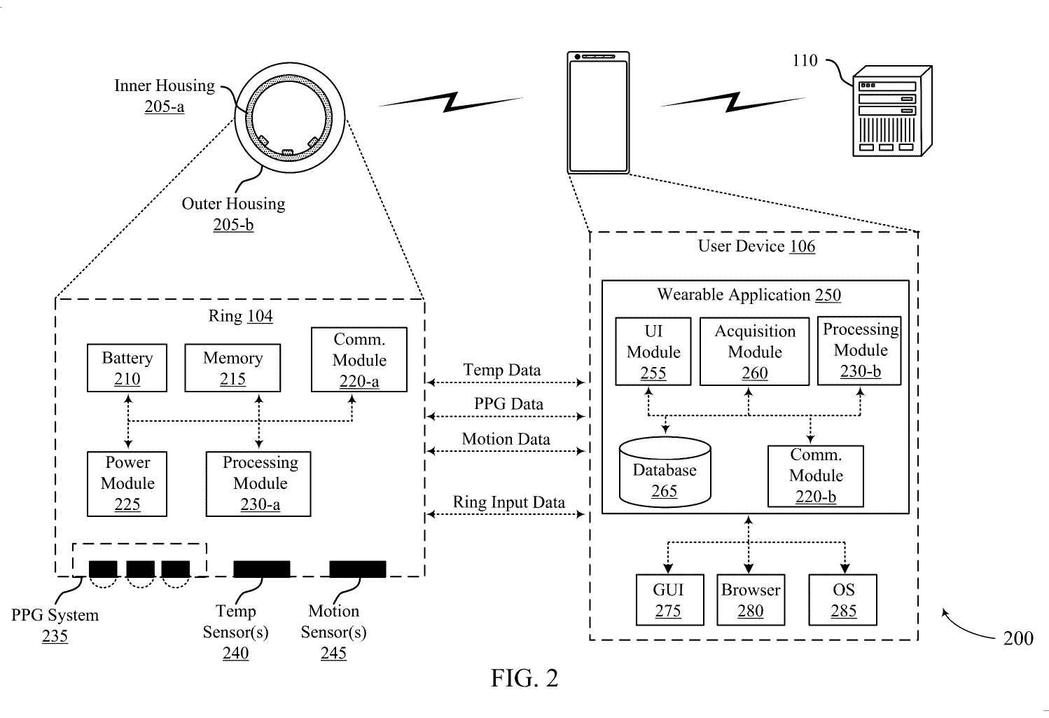

The position of the charger assembly within the charger device may vary depending on the size of the charger device. For example, for smaller charger devices, the charger assembly may be moved closer to the center of the charger device, where the electrical contact component may contact the conductive charging pads toward an end of the conductive charging pads closer to the inductive charging component. Comparatively, for larger charger devices, the charger assembly may be moved further from the center of the charger device, where the electrical contact component may contact the conductive charging pads toward an opposite end of the conductive charging pads further from the inductive charging component. The use of a single-sized charger assembly may reduce manufacturing costs of the charger device, and therefore reduce the cost of the corresponding wearable devices 104. Moreover, the conductive charging pads of the charger assembly may enable the single-sized charger assembly to fit within a wide array of charger devices, and may simplify the process of connecting the circuit board to the charger device. The charger assembly and other components are further described with reference to FIGS. 2-6.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

FIG. 2 illustrates an example of a system 200 that supports a wearable device charger in accordance with aspects of the present disclosure. The system 200 may implement, or be implemented by, system 100. In particular, system 200 illustrates an example of a ring 104 (e.g., wearable device 104), a user device 106, and a server 110, as described with reference to FIG. 1.

In some aspects, the ring 104 may be configured to be worn around a user's finger, and may determine one or more user physiological parameters when worn around the user's finger. Example measurements and determinations may include, but are not limited to, user skin temperature, pulse waveforms, respiratory rate, heart rate, HRV, blood oxygen levels (SpO2), blood sugar levels (e.g., glucose metrics), and the like.

The system 200 further includes a user device 106 (e.g., a smartphone) in communication with the ring 104. For example, the ring 104 may be in wireless and/or wired communication with the user device 106. In some implementations, the ring 104 may send measured and processed data (e.g., temperature data, photoplethysmogram (PPG) data, motion/accelerometer data, ring input data, and the like) to the user device 106. The user device 106 may also send data to the ring 104, such as ring 104 firmware/configuration updates. The user device 106 may process data. In some implementations, the user device 106 may transmit data to the server 110 for processing and/or storage.

The ring 104 may include a housing 205 that may include an inner housing 205-a and an outer housing 205-b. In some aspects, the housing 205 of the ring 104 may store or otherwise include various components of the ring including, but not limited to, device electronics, a power source (e.g., battery 210, and/or capacitor), one or more substrates (e.g., printable circuit boards) that interconnect the device electronics and/or power source, and the like. The device electronics may include device modules (e.g., hardware/software), such as: a processing module 230-a, a memory 215, a communication module 220-a, a power module 225, and the like. The device electronics may also include one or more sensors. Example sensors may include one or more temperature sensors 240, a PPG sensor assembly (e.g., PPG system 235), and one or more motion sensors 245.

The sensors may include associated modules (not illustrated) configured to communicate with the respective components/modules of the ring 104, and generate signals associated with the respective sensors. In some aspects, each of the components/modules of the ring 104 may be communicatively coupled to one another via wired or wireless connections. Moreover, the ring 104 may include additional and/or alternative sensors or other components that are configured to collect physiological data from the user, including light sensors (e.g., LEDs), oximeters, and the like.

The ring 104 shown and described with reference to FIG. 2 is provided solely for illustrative purposes. As such, the ring 104 may include additional or alternative components as those illustrated in FIG. 2. Other rings 104 that provide functionality described herein may be fabricated. For example, rings 104 with fewer components (e.g., sensors) may be fabricated. In a specific example, a ring 104 with a single temperature sensor 240 (or other sensor), a power source, and device electronics configured to read the single temperature sensor 240 (or other sensor) may be fabricated. In another specific example, a temperature sensor 240 (or other sensor) may be attached to a user's finger (e.g., using adhesives, wraps, clamps, spring loaded clamps, etc.). In this case, the sensor may be wired to another computing device, such as a wrist worn computing device that reads the temperature sensor 240 (or other sensor). In other examples, a ring 104 that includes additional sensors and processing functionality may be fabricated.

The housing 205 may include one or more housing 205 components. The housing 205 may include an outer housing 205-b component (e.g., a shell) and an inner housing 205-a component (e.g., a molding). The housing 205 may include additional components (e.g., additional layers) not explicitly illustrated in FIG. 2. For example, in some implementations, the ring 104 may include one or more insulating layers that electrically insulate the device electronics and other conductive materials (e.g., electrical traces) from the outer housing 205-b (e.g., a metal outer housing 205-b). The housing 205 may provide structural support for the device electronics, battery 210, substrate(s), and other components. For example, the housing 205 may protect the device electronics, battery 210, and substrate(s) from mechanical forces, such as pressure and impacts. The housing 205 may also protect the device electronics, battery 210, and substrate(s) from water and/or other chemicals.

The outer housing 205-b may be fabricated from one or more materials. In some implementations, the outer housing 205-b may include a metal, such as titanium, that may provide strength and abrasion resistance at a relatively light weight. The outer housing 205-b may also be fabricated from other materials, such polymers. In some implementations, the outer housing 205-b may be protective as well as decorative.

The inner housing 205-a may be configured to interface with the user's finger. The inner housing 205-a may be formed from a polymer (e.g., a medical grade polymer) or other material. In some implementations, the inner housing 205-a may be transparent. For example, the inner housing 205-a may be transparent to light emitted by the PPG light emitting diodes (LEDs). In some implementations, the inner housing 205-a component may be molded onto the outer housing 205-b. For example, the inner housing 205-a may include a polymer that is molded (e.g., injection molded) to fit into an outer housing 205-b metallic shell.

The ring 104 may include one or more substrates (not illustrated). The device electronics and battery 210 may be included on the one or more substrates. For example, the device electronics and battery 210 may be mounted on one or more substrates. Example substrates may include one or more printed circuit boards (PCBs), such as flexible PCB (e.g., polyimide). In some implementations, the electronics/battery 210 may include surface mounted devices (e.g., surface-mount technology (SMT) devices) on a flexible PCB. In some implementations, the one or more substrates (e.g., one or more flexible PCBs) may include electrical traces that provide electrical communication between device electronics. The electrical traces may also connect the battery 210 to the device electronics.

The device electronics, battery 210, and substrates may be arranged in the ring 104 in a variety of ways. In some implementations, one substrate that includes device electronics may be mounted along the bottom of the ring 104 (e.g., the bottom half), such that the sensors (e.g., PPG system 235, temperature sensors 240, motion sensors 245, and other sensors) interface with the underside of the user's finger. In these implementations, the battery 210 may be included along the top portion of the ring 104 (e.g., on another substrate).

The various components/modules of the ring 104 represent functionality (e.g., circuits and other components) that may be included in the ring 104. Modules may include any discrete and/or integrated electronic circuit components that implement analog and/or digital circuits capable of producing the functions attributed to the modules herein. For example, the modules may include analog circuits (e.g., amplification circuits, filtering circuits, analog/digital conversion circuits, and/or other signal conditioning circuits). The modules may also include digital circuits (e.g., combinational or sequential logic circuits, memory circuits etc.).

The memory 215 (memory module) of the ring 104 may include any volatile, non-volatile, magnetic, or electrical media, such as a random access memory (RAM), read-only memory (ROM), non-volatile RAM (NVRAM), electrically-erasable programmable ROM (EEPROM), flash memory, or any other memory device. The memory 215 may store any of the data described herein. For example, the memory 215 may be configured to store data (e.g., motion data, temperature data, PPG data) collected by the respective sensors and PPG system 235. Furthermore, memory 215 may include instructions that, when executed by one or more processing circuits, cause the modules to perform various functions attributed to the modules herein. The device electronics of the ring 104 described herein are only example device electronics. As such, the types of electronic components used to implement the device electronics may vary based on design considerations.

The functions attributed to the modules of the ring 104 described herein may be embodied as one or more processors, hardware, firmware, software, or any combination thereof. Depiction of different features as modules is intended to highlight different functional aspects and does not necessarily imply that such modules must be realized by separate hardware/software components. Rather, functionality associated with one or more modules may be performed by separate hardware/software components or integrated within common hardware/software components.

The processing module 230-a of the ring 104 may include one or more processors (e.g., processing units), microcontrollers, digital signal processors, systems on a chip (SOCs), and/or other processing devices. The processing module 230-a communicates with the modules included in the ring 104. For example, the processing module 230-a may transmit/receive data to/from the modules and other components of the ring 104, such as the sensors. As described herein, the modules may be implemented by various circuit components. Accordingly, the modules may also be referred to as circuits (e.g., a communication circuit and power circuit).

The processing module 230-a may communicate with the memory 215. The memory 215 may include computer-readable instructions that, when executed by the processing module 230-a, cause the processing module 230-a to perform the various functions attributed to the processing module 230-a herein. In some implementations, the processing module 230-a (e.g., a microcontroller) may include additional features associated with other modules, such as communication functionality provided by the communication module 220-a (e.g., an integrated Bluetooth Low Energy transceiver) and/or additional onboard memory 215.

The communication module 220-a may include circuits that provide wireless and/or wired communication with the user device 106 (e.g., communication module 220-b of the user device 106). In some implementations, the communication modules 220-a, 220-b may include wireless communication circuits, such as Bluetooth circuits and/or Wi-Fi circuits. In some implementations, the communication modules 220-a, 220-b can include wired communication circuits, such as Universal Serial Bus (USB) communication circuits. Using the communication module 220-a, the ring 104 and the user device 106 may be configured to communicate with each other. The processing module 230-a of the ring may be configured to transmit/receive data to/from the user device 106 via the communication module 220-a. Example data may include, but is not limited to, motion data, temperature data, pulse waveforms, heart rate data, HRV data, PPG data, and status updates (e.g., charging status, battery charge level, and/or ring 104 configuration settings). The processing module 230-a of the ring may also be configured to receive updates (e.g., software/firmware updates) and data from the user device 106.

The ring 104 may include a battery 210 (e.g., a rechargeable battery 210). An example battery 210 may include a Lithium-Ion or Lithium-Polymer type battery 210, although a variety of battery 210 options are possible. The battery 210 may be wirelessly charged. In some implementations, the ring 104 may include a power source other than the battery 210, such as a capacitor. The power source (e.g., battery 210 or capacitor) may have a curved geometry that matches the curve of the ring 104. In some aspects, a charger or other power source may include additional sensors that may be used to collect data in addition to, or that supplements, data collected by the ring 104 itself. Moreover, a charger or other power source for the ring 104 may function as a user device 106, in which case the charger or other power source for the ring 104 may be configured to receive data from the ring 104, store and/or process data received from the ring 104, and communicate data between the ring 104 and the servers 110.

In some aspects, the ring 104 includes a power module 225 that may control charging of the battery 210. For example, the power module 225 may interface with an external wireless charger that charges the battery 210 when interfaced with the ring 104. The charger may include a datum structure that mates with a ring 104 datum structure to create a specified orientation with the ring 104 during charging. The power module 225 may also regulate voltage(s) of the device electronics, regulate power output to the device electronics, and monitor the state of charge of the battery 210. In some implementations, the battery 210 may include a protection circuit module (PCM) that protects the battery 210 from high current discharge, over voltage during charging, and under voltage during discharge. The power module 225 may also include electro-static discharge (ESD) protection.

The one or more temperature sensors 240 may be electrically coupled to the processing module 230-a. The temperature sensor 240 may be configured to generate a temperature signal (e.g., temperature data) that indicates a temperature read or sensed by the temperature sensor 240. The processing module 230-a may determine a temperature of the user in the location of the temperature sensor 240. For example, in the ring 104, temperature data generated by the temperature sensor 240 may indicate a temperature of a user at the user's finger (e.g., skin temperature). In some implementations, the temperature sensor 240 may contact the user's skin. In other implementations, a portion of the housing 205 (e.g., the inner housing 205-a) may form a barrier (e.g., a thin, thermally conductive barrier) between the temperature sensor 240 and the user's skin. In some implementations, portions of the ring 104 configured to contact the user's finger may have thermally conductive portions and thermally insulative portions. The thermally conductive portions may conduct heat from the user's finger to the temperature sensors 240. The thermally insulative portions may insulate portions of the ring 104 (e.g., the temperature sensor 240) from ambient temperature.

In some implementations, the temperature sensor 240 may generate a digital signal (e.g., temperature data) that the processing module 230-a may use to determine the temperature. As another example, in cases where the temperature sensor 240 includes a passive sensor, the processing module 230-a (or a temperature sensor 240 module) may measure a current/voltage generated by the temperature sensor 240 and determine the temperature based on the measured current/voltage. Example temperature sensors 240 may include a thermistor, such as a negative temperature coefficient (NTC) thermistor, or other types of sensors including resistors, transistors, diodes, and/or other electrical/electronic components.

The processing module 230-a may sample the user's temperature over time. For example, the processing module 230-a may sample the user's temperature according to a sampling rate. An example sampling rate may include one sample per second, although the processing module 230-a may be configured to sample the temperature signal at other sampling rates that are higher or lower than one sample per second. In some implementations, the processing module 230-a may sample the user's temperature continuously throughout the day and night. Sampling at a sufficient rate (e.g., one sample per second) throughout the day may provide sufficient temperature data for analysis described herein.

The processing module 230-a may store the sampled temperature data in memory 215. In some implementations, the processing module 230-a may process the sampled temperature data. For example, the processing module 230-a may determine average temperature values over a period of time. In one example, the processing module 230-a may determine an average temperature value each minute by summing all temperature values collected over the minute and dividing by the number of samples over the minute. In a specific example where the temperature is sampled at one sample per second, the average temperature may be a sum of all sampled temperatures for one minute divided by sixty seconds. The memory 215 may store the average temperature values over time. In some implementations, the memory 215 may store average temperatures (e.g., one per minute) instead of sampled temperatures in order to conserve memory 215.

The sampling rate, which may be stored in memory 215, may be configurable. In some implementations, the sampling rate may be the same throughout the day and night. In other implementations, the sampling rate may be changed throughout the day/night. In some implementations, the ring 104 may filter/reject temperature readings, such as large spikes in temperature that are not indicative of physiological changes (e.g., a temperature spike from a hot shower). In some implementations, the ring 104 may filter/reject temperature readings that may not be reliable due to other factors, such as excessive motion during exercise (e.g., as indicated by a motion sensor 245).

The ring 104 (e.g., communication module) may transmit the sampled and/or average temperature data to the user device 106 for storage and/or further processing. The user device 106 may transfer the sampled and/or average temperature data to the server 110 for storage and/or further processing.

Although the ring 104 is illustrated as including a single temperature sensor 240, the ring 104 may include multiple temperature sensors 240 in one or more locations, such as arranged along the inner housing 205-a near the user's finger. In some implementations, the temperature sensors 240 may be stand-alone temperature sensors 240. Additionally, or alternatively, one or more temperature sensors 240 may be included with other components (e.g., packaged with other components), such as with the accelerometer and/or processor.

The processing module 230-a may acquire and process data from multiple temperature sensors 240 in a similar manner described with respect to a single temperature sensor 240. For example, the processing module 230 may individually sample, average, and store temperature data from each of the multiple temperature sensors 240. In other examples, the processing module 230-a may sample the sensors at different rates and average/store different values for the different sensors. In some implementations, the processing module 230-a may be configured to determine a single temperature based on the average of two or more temperatures determined by two or more temperature sensors 240 in different locations on the finger.

The temperature sensors 240 on the ring 104 may acquire distal temperatures at the user's finger (e.g., any finger). For example, one or more temperature sensors 240 on the ring 104 may acquire a user's temperature from the underside of a finger or at a different location on the finger. In some implementations, the ring 104 may continuously acquire distal temperature (e.g., at a sampling rate). Although distal temperature measured by a ring 104 at the finger is described herein, other devices may measure temperature at the same/different locations. In some cases, the distal temperature measured at a user's finger may differ from the temperature measured at a user's wrist or other external body location. Additionally, the distal temperature measured at a user's finger (e.g., a “shell” temperature) may differ from the user's core temperature. As such, the ring 104 may provide a useful temperature signal that may not be acquired at other internal/external locations of the body. In some cases, continuous temperature measurement at the finger may capture temperature fluctuations (e.g., small or large fluctuations) that may not be evident in core temperature. For example, continuous temperature measurement at the finger may capture minute-to-minute or hour-to-hour temperature fluctuations that provide additional insight that may not be provided by other temperature measurements elsewhere in the body.

The ring 104 may include a PPG system 235. The PPG system 235 may include one or more optical transmitters that transmit light. The PPG system 235 may also include one or more optical receivers that receive light transmitted by the one or more optical transmitters. An optical receiver may generate a signal (hereinafter “PPG” signal) that indicates an amount of light received by the optical receiver. The optical transmitters may illuminate a region of the user's finger. The PPG signal generated by the PPG system 235 may indicate the perfusion of blood in the illuminated region. For example, the PPG signal may indicate blood volume changes in the illuminated region caused by a user's pulse pressure. The processing module 230-a may sample the PPG signal and determine a user's pulse waveform based on the PPG signal. The processing module 230-a may determine a variety of physiological parameters based on the user's pulse waveform, such as a user's respiratory rate, heart rate, HRV, oxygen saturation, and other circulatory parameters.

In some implementations, the PPG system 235 may be configured as a reflective PPG system 235 where the optical receiver(s) receive transmitted light that is reflected through the region of the user's finger. In some implementations, the PPG system 235 may be configured as a transmissive PPG system 235 where the optical transmitter(s) and optical receiver(s) are arranged opposite to one another, such that light is transmitted directly through a portion of the user's finger to the optical receiver(s).

The number and ratio of transmitters and receivers included in the PPG system 235 may vary. Example optical transmitters may include light-emitting diodes (LEDs). The optical transmitters may transmit light in the infrared spectrum and/or other spectrums. Example optical receivers may include, but are not limited to, photosensors, phototransistors, and photodiodes. The optical receivers may be configured to generate PPG signals in response to the wavelengths received from the optical transmitters. The location of the transmitters and receivers may vary. Additionally, a single device may include reflective and/or transmissive PPG systems 235.

The PPG system 235 illustrated in FIG. 2 may include a reflective PPG system 235 in some implementations. In these implementations, the PPG system 235 may include a centrally located optical receiver (e.g., at the bottom of the ring 104) and two optical transmitters located on each side of the optical receiver. In this implementation, the PPG system 235 (e.g., optical receiver) may generate the PPG signal based on light received from one or both of the optical transmitters. In other implementations, other placements, combinations, and/or configurations of one or more optical transmitters and/or optical receivers are contemplated.

The processing module 230-a may control one or both of the optical transmitters to transmit light while sampling the PPG signal generated by the optical receiver. In some implementations, the processing module 230-a may cause the optical transmitter with the stronger received signal to transmit light while sampling the PPG signal generated by the optical receiver. For example, the selected optical transmitter may continuously emit light while the PPG signal is sampled at a sampling rate (e.g., 250 Hz).

Sampling the PPG signal generated by the PPG system 235 may result in a pulse waveform that may be referred to as a “PPG.” The pulse waveform may indicate blood pressure vs time for multiple cardiac cycles. The pulse waveform may include peaks that indicate cardiac cycles. Additionally, the pulse waveform may include respiratory induced variations that may be used to determine respiration rate. The processing module 230-a may store the pulse waveform in memory 215 in some implementations. The processing module 230-a may process the pulse waveform as it is generated and/or from memory 215 to determine user physiological parameters described herein.

The processing module 230-a may determine the user's heart rate based on the pulse waveform. For example, the processing module 230-a may determine heart rate (e.g., in beats per minute) based on the time between peaks in the pulse waveform. The time between peaks may be referred to as an interbeat interval (IBI). The processing module 230-a may store the determined heart rate values and IBI values in memory 215.

The processing module 230-a may determine HRV over time. For example, the processing module 230-a may determine HRV based on the variation in the IBIs. The processing module 230-a may store the HRV values over time in the memory 215. Moreover, the processing module 230-a may determine the user's respiratory rate over time. For example, the processing module 230-a may determine respiratory rate based on frequency modulation, amplitude modulation, or baseline modulation of the user's IBI values over a period of time. Respiratory rate may be calculated in breaths per minute or as another breathing rate (e.g., breaths per 30 seconds). The processing module 230-a may store user respiratory rate values over time in the memory 215.

The ring 104 may include one or more motion sensors 245, such as one or more accelerometers (e.g., 6-D accelerometers) and/or one or more gyroscopes (gyros). The motion sensors 245 may generate motion signals that indicate motion of the sensors. For example, the ring 104 may include one or more accelerometers that generate acceleration signals that indicate acceleration of the accelerometers. As another example, the ring 104 may include one or more gyro sensors that generate gyro signals that indicate angular motion (e.g., angular velocity) and/or changes in orientation. The motion sensors 245 may be included in one or more sensor packages. An example accelerometer/gyro sensor is a Bosch BM1160 inertial micro electro-mechanical system (MEMS) sensor that may measure angular rates and accelerations in three perpendicular axes.

The processing module 230-a may sample the motion signals at a sampling rate (e.g., 50 Hz) and determine the motion of the ring 104 based on the sampled motion signals. For example, the processing module 230-a may sample acceleration signals to determine acceleration of the ring 104. As another example, the processing module 230-a may sample a gyro signal to determine angular motion. In some implementations, the processing module 230-a may store motion data in memory 215. Motion data may include sampled motion data as well as motion data that is calculated based on the sampled motion signals (e.g., acceleration and angular values).

The ring 104 may store a variety of data described herein. For example, the ring 104 may store temperature data, such as raw sampled temperature data and calculated temperature data (e.g., average temperatures). As another example, the ring 104 may store PPG signal data, such as pulse waveforms and data calculated based on the pulse waveforms (e.g., heart rate values, IBI values, HRV values, and respiratory rate values). The ring 104 may also store motion data, such as sampled motion data that indicates linear and angular motion.

The ring 104, or other computing device, may calculate and store additional values based on the sampled/calculated physiological data. For example, the processing module 230 may calculate and store various metrics, such as sleep metrics (e.g., a Sleep Score), activity metrics, and readiness metrics. In some implementations, additional values/metrics may be referred to as “derived values.” The ring 104, or other computing/wearable device, may calculate a variety of values/metrics with respect to motion. Example derived values for motion data may include, but are not limited to, motion count values, regularity values, intensity values, metabolic equivalence of task values (METs), and orientation values. Motion counts, regularity values, intensity values, and METs may indicate an amount of user motion (e.g., velocity/acceleration) over time. Orientation values may indicate how the ring 104 is oriented on the user's finger and if the ring 104 is worn on the left hand or right hand.

In some implementations, motion counts and regularity values may be determined by counting a number of acceleration peaks within one or more periods of time (e.g., one or more 30 second to 1 minute periods). Intensity values may indicate a number of movements and the associated intensity (e.g., acceleration values) of the movements. The intensity values may be categorized as low, medium, and high, depending on associated threshold acceleration values. METs may be determined based on the intensity of movements during a period of time (e.g., 30 seconds), the regularity/irregularity of the movements, and the number of movements associated with the different intensities.

In some implementations, the processing module 230-a may compress the data stored in memory 215. For example, the processing module 230-a may delete sampled data after making calculations based on the sampled data. As another example, the processing module 230-a may average data over longer periods of time in order to reduce the number of stored values. In a specific example, if average temperatures for a user over one minute are stored in memory 215, the processing module 230-a may calculate average temperatures over a five minute time period for storage, and then subsequently erase the one minute average temperature data. The processing module 230-a may compress data based on a variety of factors, such as the total amount of used/available memory 215 and/or an elapsed time since the ring 104 last transmitted the data to the user device 106.

Although a user's physiological parameters may be measured by sensors included on a ring 104, other devices may measure a user's physiological parameters. For example, although a user's temperature may be measured by a temperature sensor 240 included in a ring 104, other devices may measure a user's temperature. In some examples, other wearable devices (e.g., wrist devices) may include sensors that measure user physiological parameters. Additionally, medical devices, such as external medical devices (e.g., wearable medical devices) and/or implantable medical devices, may measure a user's physiological parameters. One or more sensors on any type of computing device may be used to implement the techniques described herein.

The physiological measurements may be taken continuously throughout the day and/or night. In some implementations, the physiological measurements may be taken during portions of the day and/or portions of the night. In some implementations, the physiological measurements may be taken in response to determining that the user is in a specific state, such as an active state, resting state, and/or a sleeping state. For example, the ring 104 can make physiological measurements in a resting/sleep state in order to acquire cleaner physiological signals. In one example, the ring 104 or other device/system may detect when a user is resting and/or sleeping and acquire physiological parameters (e.g., temperature) for that detected state. The devices/systems may use the resting/sleep physiological data and/or other data when the user is in other states in order to implement the techniques of the present disclosure.

In some implementations, as described previously herein, the ring 104 may be configured to collect, store, and/or process data, and may transfer any of the data described herein to the user device 106 for storage and/or processing. In some aspects, the user device 106 includes a wearable application 250, an operating system (OS), a web browser application (e.g., web browser 280), one or more additional applications, and a GUI 275. The user device 106 may further include other modules and components, including sensors, audio devices, haptic feedback devices, and the like. The wearable application 250 may include an example of an application (e.g., “app”) that may be installed on the user device 106. The wearable application 250 may be configured to acquire data from the ring 104, store the acquired data, and process the acquired data as described herein. For example, the wearable application 250 may include a user interface (UI) module 255, an acquisition module 260, a processing module 230-b, a communication module 220-b, and a storage module (e.g., database 265) configured to store application data.

The various data processing operations described herein may be performed by the ring 104, the user device 106, the servers 110, or any combination thereof. For example, in some cases, data collected by the ring 104 may be pre-processed and transmitted to the user device 106. In this example, the user device 106 may perform some data processing operations on the received data, may transmit the data to the servers 110 for data processing, or both. For instance, in some cases, the user device 106 may perform processing operations that require relatively low processing power and/or operations that require a relatively low latency, whereas the user device 106 may transmit the data to the servers 110 for processing operations that require relatively high processing power and/or operations that may allow relatively higher latency.

In some aspects, the ring 104, user device 106, and server 110 of the system 200 may be configured to evaluate sleep patterns for a user. In particular, the respective components of the system 200 may be used to collect data from a user via the ring 104, and generate one or more scores (e.g., Sleep Score, Readiness Score) for the user based on the collected data. For example, as noted previously herein, the ring 104 of the system 200 may be worn by a user to collect data from the user, including temperature, heart rate, HRV, and the like. Data collected by the ring 104 may be used to determine when the user is asleep in order to evaluate the user's sleep for a given “sleep day.” In some aspects, scores may be calculated for the user for each respective sleep day, such that a first sleep day is associated with a first set of scores, and a second sleep day is associated with a second set of scores. Scores may be calculated for each respective sleep day based on data collected by the ring 104 during the respective sleep day. Scores may include, but are not limited to, Sleep Scores, Readiness Scores, and the like.

In some cases, “sleep days” may align with the traditional calendar days, such that a given sleep day runs from midnight to midnight of the respective calendar day. In other cases, sleep days may be offset relative to calendar days. For example, sleep days may run from 6:00 pm (18:00) of a calendar day until 6:00 pm (18:00) of the subsequent calendar day. In this example, 6:00 pm may serve as a “cut-off time,” where data collected from the user before 6:00 pm is counted for the current sleep day, and data collected from the user after 6:00 pm is counted for the subsequent sleep day. Due to the fact that most individuals sleep the most at night, offsetting sleep days relative to calendar days may enable the system 200 to evaluate sleep patterns for users in such a manner that is consistent with their sleep schedules. In some cases, users may be able to selectively adjust (e.g., via the GUI) a timing of sleep days relative to calendar days so that the sleep days are aligned with the duration of time that the respective users typically sleep.

In some implementations, each overall score for a user for each respective day (e.g., Sleep Score, Readiness Score) may be determined/calculated based on one or more “contributors,” “factors,” or “contributing factors.” For example, a user's overall Sleep Score may be calculated based on a set of contributors, including: total sleep, efficiency, restfulness, REM sleep, deep sleep, latency, timing, or any combination thereof. The Sleep Score may include any quantity of contributors. The “total sleep” contributor may refer to the sum of all sleep periods of the sleep day. The “efficiency” contributor may reflect the percentage of time spent asleep compared to time spent awake while in bed, and may be calculated using the efficiency average of long sleep periods (e.g., primary sleep period) of the sleep day, weighted by a duration of each sleep period. The “restfulness” contributor may indicate how restful the user's sleep is, and may be calculated using the average of all sleep periods of the sleep day, weighted by a duration of each period. The restfulness contributor may be based on a “wake up count” (e.g., sum of all the wake-ups (when user wakes up) detected during different sleep periods), excessive movement, and a “got up count” (e.g., sum of all the got-ups (when user gets out of bed) detected during the different sleep periods).

The “REM sleep” contributor may refer to a sum total of REM sleep durations across all sleep periods of the sleep day including REM sleep. Similarly, the “deep sleep” contributor may refer to a sum total of deep sleep durations across all sleep periods of the sleep day including deep sleep. The “latency” contributor may signify how long (e.g., average, median, longest) the user takes to go to sleep, and may be calculated using the average of long sleep periods throughout the sleep day, weighted by a duration of each period and the number of such periods (e.g., consolidation of a given sleep stage or sleep stages may be its own contributor or weight other contributors). Lastly, the “timing” contributor may refer to a relative timing of sleep periods within the sleep day and/or calendar day, and may be calculated using the average of all sleep periods of the sleep day, weighted by a duration of each period.

By way of another example, a user's overall Readiness Score may be calculated based on a set of contributors, including: sleep, sleep balance, heart rate, HRV balance, recovery index, temperature, activity, activity balance, or any combination thereof. The Readiness Score may include any quantity of contributors. The “sleep” contributor may refer to the combined Sleep Score of all sleep periods within the sleep day. The “sleep balance” contributor may refer to a cumulative duration of all sleep periods within the sleep day. In particular, sleep balance may indicate to a user whether the sleep that the user has been getting over some duration of time (e.g., the past two weeks) is in balance with the user's needs. Typically, adults need 7-9 hours of sleep a night to stay healthy, alert, and to perform at their best both mentally and physically. However, it is normal to have an occasional night of bad sleep, so the sleep balance contributor takes into account long-term sleep patterns to determine whether each user's sleep needs are being met. The “resting heart rate” contributor may indicate a lowest heart rate from the longest sleep period of the sleep day (e.g., primary sleep period) and/or the lowest heart rate from naps occurring after the primary sleep period.

Continuing with reference to the “contributors” (e.g., factors, contributing factors) of the Readiness Score, the “HRV balance” contributor may indicate a highest HRV average from the primary sleep period and the naps happening after the primary sleep period. The HRV balance contributor may help users keep track of their recovery status by comparing their HRV trend over a first time period (e.g., two weeks) to an average HRV over some second, longer time period (e.g., three months). The “recovery index” contributor may be calculated based on the longest sleep period. Recovery index measures how long it takes for a user's resting heart rate to stabilize during the night. A sign of a very good recovery is that the user's resting heart rate stabilizes during the first half of the night, at least six hours before the user wakes up, leaving the body time to recover for the next day. The “body temperature” contributor may be calculated based on the longest sleep period (e.g., primary sleep period) or based on a nap happening after the longest sleep period if the user's highest temperature during the nap is at least 0.5° C. higher than the highest temperature during the longest period. In some aspects, the ring may measure a user's body temperature while the user is asleep, and the system 200 may display the user's average temperature relative to the user's baseline temperature. If a user's body temperature is outside of their normal range (e.g., clearly above or below 0.0), the body temperature contributor may be highlighted (e.g., go to a “Pay attention” state) or otherwise generate an alert for the user.

In some aspects, the system 200 may support a charger device (e.g., charging device) for charging the ring 104. The charger device may include a charger assembly that is manufactured in a single size for a wide range of charger sizes, and thus support a wide range of ring 104 sizes. The charger assembly includes an inductive charging component, conductive charging pads that extend a length of the charger assembly, and other additional components. An electrical contact component of a circuit board may contact the conductive charging pads at any point along the charging pads to electrically couple the circuit board to the inductive charging component.

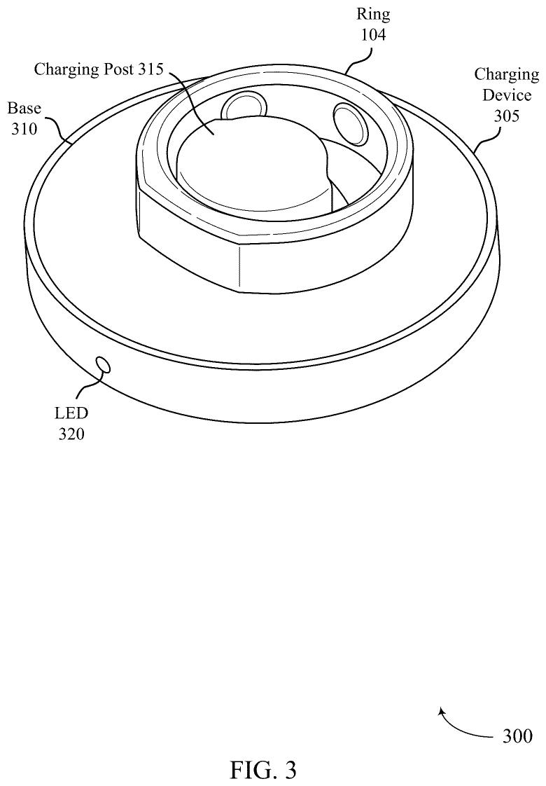

The position of the charger assembly within the charger device may vary depending on the size of the charger device. For example, for smaller charger devices, the charger assembly may be moved closer to the center of the charger device. Comparatively, for larger charger devices, the charger assembly may be moved further from the center of the charger device. The use of a single-sized charger assembly may reduce manufacturing costs of the charger device, and therefore reduce the cost of the corresponding wearable devices 104. Moreover, the conductive charging pads of the charger assembly may enable the single-sized charger assembly to fit within a wide array of charger devices, and may simplify the process of connecting the circuit board to the charger device. The charger assembly and other components are further described with reference to FIGS. 3-6.

FIG. 3 shows an example of a charging device diagram 300 that supports a wearable device charger in accordance with aspects of the present disclosure. The charging device diagram 300 may implement, or be implemented by, system 100, system 200, or both. In particular, the charging device diagram 300 illustrates an example of a ring 104 (e.g., wearable device 104, device, wearable ring device), as described with reference to FIG. 1, interacting with a charging device 305 (e.g., charger, charger device, wearable device charger), which may charge the battery of the wearable device 104. Although the wearable device 104 is illustrated as a ring in FIG. 3, the wearable device 104 may be any example of any wearable device 104 (e.g., a watch, necklace, bracelet, and the like).

The charging device 305 may communicate with the ring 104, a user device, a server, or a combination thereof. Communications may be wireless or wired. In some implementations, the charging device 305 may send measured and processed data (e.g., temperature data, humidity data, noise data, and the like) to the ring 104, the user device, the server, or a combination thereof.

In some implementations, the charging device 305 may include a wired or wireless power source. In some examples, the charging device 305 may be coupled with an electrical outlet or other power source. In some examples, the charging device 305 may include a battery or other internal power source to enable mobile charging of the ring 104. For example, in some implementations, the charging device 305 may include a battery or other internal power source such that a user may physically wear or carry the charging device 305 along with the ring 104 for mobile charging. For instance, the charging device 305 may be worn on a necklace so that a user may wear the charging device 305 while simultaneously charging the ring 104. In other cases, the charging device 305 may be coupled with the ring 104 (e.g., magnetically coupled, mechanically snapped onto) while the ring 104 is being worn so that the ring 104 may be charged (and continue to collect physiological data) as it is worn.

In some examples, the charging device 305 may include a base 310 and a charging post 315 (e.g., a supporting component, a support). The charging device 305 may be manufactured according to an inner diameter of the ring 104. Moreover, the charging device 305 may be manufactured to provide wireless charging to rings 104 of multiple sizes. In this regard, a circumference and/or diameter of the charging post 315 may be smaller than an inner diameter of a smallest wearable device 104 (e.g., of a plurality of rings 104 of different sizes), such that the smallest ring 104 may be positioned around the charging post 315. Further, any ring 104 of the multiple sizes may at least partially surround the charging post 315, enabling the ring 104 to couple with the charging post 315 for charging.

Additionally, or alternatively, the charging device 305 may be manufactured such that a threshold distance between the inner surface of the ring 104 and the charging post 315 connected to the base 310 of the charging device 305 is below a threshold distance. The threshold distance may be determined based on a distance for wireless charging (e.g., where one or more inductive charging components of the ring 104 are within a threshold distance of inductive charging components of charging device 305 to induce current to charge the ring 104). However, manufacturing different sizes or shapes of charging posts 315 based on a size and shape of a ring 104 may incur unnecessary cost, and increase the cost of the ring 104.

In some cases, the ring 104 may be oriented (e.g., by a user) in one of a plurality of radial orientations (e.g., defined relative to an axis of the charging post 315), where a positioning of the charging component of the ring 104 may vary based on the radial orientation. However, the charging component may not be within the threshold distance at some of the plurality of radial orientations, and the ring 104 may charge slowly or not charge when oriented in these radial orientations. Accordingly, the mechanical force exerted by the mechanical components and/or the magnetic force exerted by the magnetic components may be configured to position the ring 104 on the base 310 in a single radial orientation of a plurality of radial orientations. In the single radial orientation, the charging components of the ring 104 may be positioned and maintained within the threshold distance of the charging components of the charging device 305, thereby enabling effective charging of the ring 104. Additionally, or alternatively, the mechanical and/or magnetic force(s) may prevent the ring 104 from coupling with the charging device 305 (e.g., the base 310) when the ring 104 is oriented in a subset of the plurality of radial orientations excluding the single radial orientation. In some examples, the magnetic components of the charging device 305 may be configured to exert a tangential force (e.g., rotational force) on the ring 104, where the mechanical components exert a linear force against the ring 104. In some cases, the mechanical and magnetic forces may or may not be aligned with one another. To facilitate positioning of the ring 104, magnetic components of the charging device 305 (e.g., within the base 310 or the charging post 315) may be arranged in a pattern. The pattern may be based on a polarity of each magnet of a plurality of magnets of the charging device 105, which may enhance attraction to magnetic components of the ring 104.

In some examples, the charging device 305 may include an LED 320 to display a charging status. For example, the LED 320 may blink while wearable device 104-a is actively charging, and may turn solid when the ring 104 has reached a maximum or threshold charge. Additionally, or alternatively, the LED 320 may emit a first color while the ring 104 is actively charging and a second color when the ring 104 has reached a maximum or threshold charge. In some cases, the LED 320 may indicate one or more alerts to the user (e.g., by changing colors, blinking, flashing, etc.). For example, the LED 320 may turn red if there is a charging malfunction (e.g., connectivity issues), or the like. In some cases, the charging post 315 may be capable of charging multiple rings 104. The LED 320 may indicate which of the multiple rings or other wearable devices may be charged using different colors or flashing patterns.

As noted previously herein, the ring 104 may not properly charge if the ring 104 does not fit snugly against/around the charging post 315. As such, in some implementations, the charging device 305 may include one or more mechanical components on or within the base 310 or the charging post 315 of the charging device 305 to help align and hold the ring 104 against the charging components of the charging device 305. For example, the charging device 305 may include one or more flaps, springs, or other mechanical components that exert a mechanical force against the ring 104 to help position the ring 104 on the charging device 305 for charging. Additionally, or alternatively, the charging device 305 may include one or more components to magnetically attract a magnetic component on or within the ring 104. For example, the charging post 315 may include a magnet (e.g., a rare earth magnet, ferrite tape, a transmitter coil, or the like), and the ring 104 may include a similar magnet. The magnets or magnetic components may create a magnetic force (e.g., a mechanical force exerted via the magnets) to orient the ring 104 in a charging position and to ensure a charging component of the ring 104 remains within a threshold distance of charging components of the charging device 305 located within the charging post 315.

In additional or alternative implementations, the charging device 305 may be manufactured in multiple discrete sizes that correspond to different sized rings 104. The use of multiple discrete sized charging devices 305 may reduce or negate the need to use “mechanical components” that help position the ring 104 on the charger. Further, the use of multiple discrete sized charging devices 305 may provide a more “customized” look and feel of the ring 104 as a whole, and may lead to an elevated, improved customer experience. However, as noted previously herein, manufacturing multiple discrete sized charging devices 305 may lead to increased cost, which may increase the cost of the ring 104 itself.

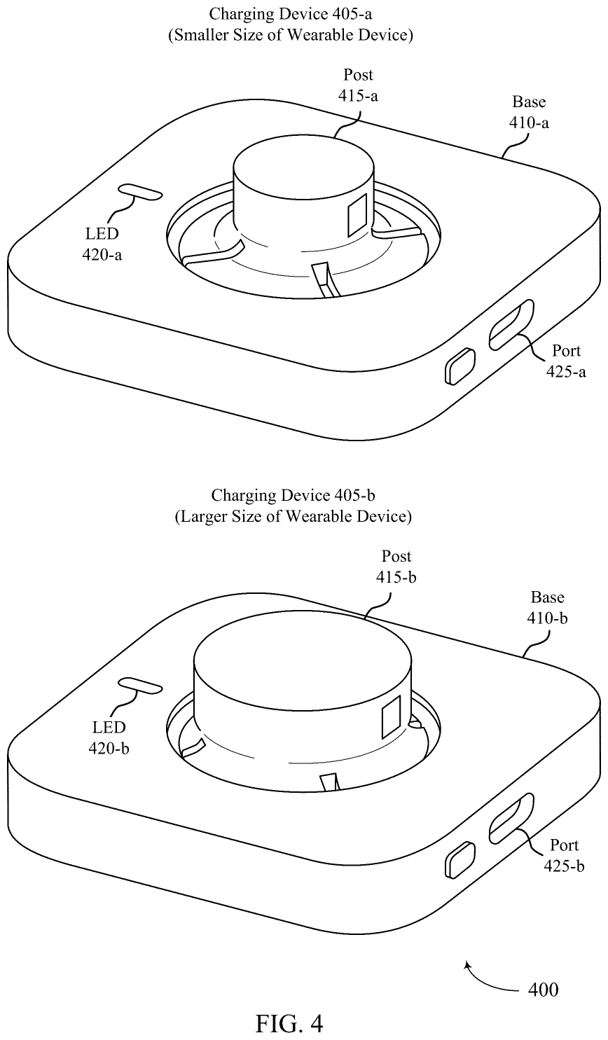

As such, aspects of the present disclosure are directed to a “charger assembly” that is compatible with multiple sizes of charging devices 305, thereby reducing the quantity of individual components of the charging devices 305 that have to be manufactured. For example, in some aspects, the charging device 305 may include a charger assembly, which may include various components, such as an inductive charging component and charging pads. The inductive charging component may charge the ring 104 through the housing of the charging device 305. The charging pads may be in contact with an electrical contact component of a circuit board. The electrical contact component may contact the charging pads in different locations along the charging pads, resulting in a movable charger assembly. The charger assembly may be manufactured in a single size for various sizes of charging devices, resulting in reduced manufacturing costs of the charging device 305 due to a reduction in the quantity of discrete sizes of charging device 305. Different sizes of the charging device 305 (which are all compatible with the single-sized charger assembly) are further described and illustrated with reference to FIG. 4.

FIG. 4 shows an example of a charging device diagram 400 that supports a wearable device charger in accordance with aspects of the present disclosure. The charging device diagram 400 may implement, or be implemented by, aspects of the system 100, system 200, charging device diagram 300, or any combination thereof. The charging device diagram 400 depicts examples of different sizes of charging devices 405 (e.g., a first charging device 405-a and a second charging device 405-b), which may be examples of the charging device 305 as described with reference to FIG. 3.

Each charging device 405 includes a base 410, a charging post 415, and an LED 420, which may be examples of the base 310, the charging post 315, and the LED 320 as described with reference to FIG. 3. The base 410 and the charging post 415 may collectively make up a “charger housing” of the respective charging device 405. Further, the charging device 405 may include a port 425. The charging devices 405 may be used to charge a wearable device, such as a ring 104. Further, in some implementations, the charging devices 405 may include a “well” or depression that at least partially surrounds the charging post 415, where the well/depression helps align and orient the wearable ring device 104 on the charging post 415. In some aspects, the charging post 415 and/or the well/depression may include one or more mechanical features (e.g., grooves, channels, detents) that engage one or more mechanical features of the ring 104 to help orient and position the ring 104 on/around the charging post 415 in the correct radial orientation for charging.

As shown in FIG. 4, the first charging device 405-a may be manufactured to fit and charge a smaller wearable ring device 104, and the second charging device 405-b may be manufactured to fit and charger a larger wearable ring device 104. For example, the charging post 415-a of the first charging device 405-a may exhibit a first diameter or circumference that fits a ring size 6, and the charging post 415-b of the second charging device 405-b may exhibit a second diameter or circumference that fits a ring size 10. The different sizes of the charging posts 415, while maintaining a consistent base 410, allows for increased flexibility for different sized rings and reduces manufacturing complexity. For example, the base 410-a and the base 410-b may be the same size, where different sized charging posts 415 may be “snapped” or otherwise coupled to the single-sized base 410. The port 425-a and the port 425-b may be used for wired charging, such as connecting the charging device 405 to an external power source. The LED 420-a may be positioned as part of the base 410-a, and the LED 420-b may be positioned as part of the base 410-b.

In additional or alternative implementations, as will be described in further detail herein, the diameter or circumference of the charging post 415 may be modified to fit different sized rings 104. In other words, a single charging device 405 may be transitioned between the sizes illustrated by the first charging device 405-a and the second charging device 405-b. For example, rotation of the charging post 415 may cause the diameter/circumference of the charging post 415 to expand or contract.

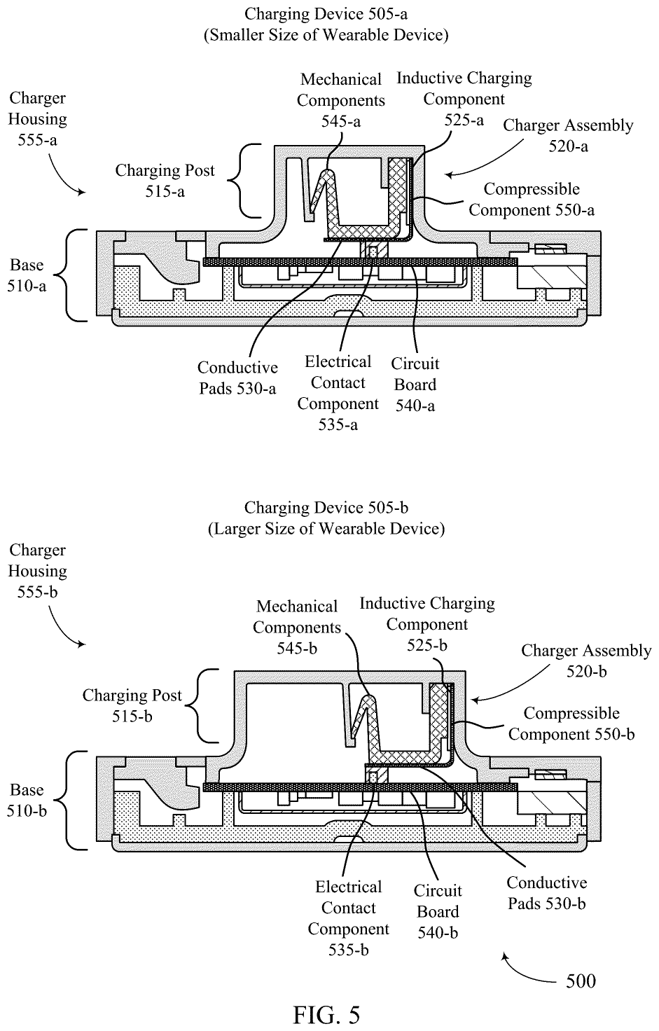

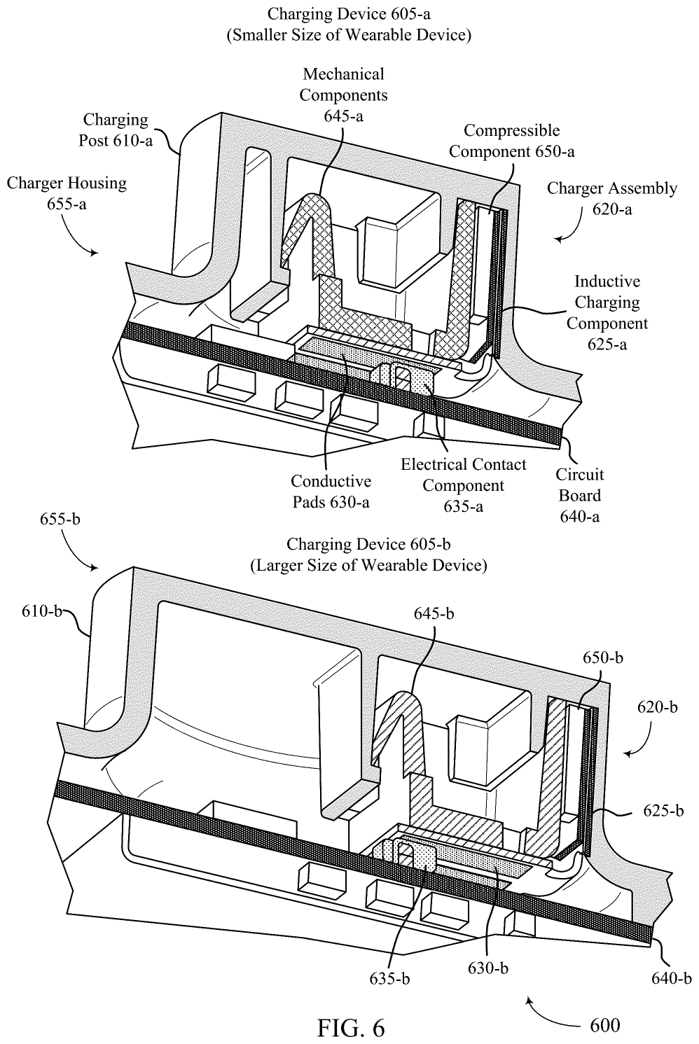

As noted previously herein, the base 410 and the charging post 415 may collectively make up a “charger housing” of the respective charging device 405. In some aspects, the charger housing of the respective charging devices 405 may include a charger assembly. The charger assembly may include components that are the same for multiple sizes of the wearable device, enabling both the larger charging device 405-b and the smaller charging device 405-a to be manufactured using the same internal components. In other words, the first charging device 405-a and the second charging device 405-b, which are manufactured for varying sized rings, may both include or otherwise be compatible with a single “charger assembly” that is manufactured in a single size. The single sized “charger assembly” that is compatible with varying sized charging devices 405 will be further shown and described with respect to FIGS. 5 and 6.

FIG. 5 shows an example of a charging device diagram 500 that supports a wearable device charger in accordance with aspects of the present disclosure. The charging device diagram 500 may implement, or be implemented by, aspects of the system 100, system 200, charging device diagram 300, the charging device diagram 400, or any combination thereof.

The charging device diagram 500 depicts cross-sections of a charging device 505-a and a charging device 505-b, which may be examples of the charging device 405-a and the charging device 405-b described with reference to FIG. 4, respectively. In other words, the first charging device 505-a in FIG. 5 illustrates a cross-sectional view of the charging device 405-a for a smaller wearable device illustrated in FIG. 4, and the second charging device 505-b in FIG. 5 illustrates a cross-sectional view of the charging device 405-b for a larger wearable device illustrated in FIG. 4. Each charging device includes a base 510 and a charging post 515, which may be examples of the base 310 and the post 315 as described with reference to FIG. 3. As shown in FIG. 5, the charging post 515-a of the first charging device 505-a may exhibit a first diameter or circumference to fit a ring of a first size (e.g., U.S. ring size 6), and the charging post 515-b of the second charging device 505-b may exhibit a second (larger) diameter or circumference to fit a ring of a second (larger) size (e.g., U.S. ring size 10). Collectively, the base 510 and the charging post 515 may make up a “charger housing 555” of the respective charging device 505. In some aspects, the bases 510-a, 510-b of the respective charging devices 505-a, 505-b may be the same size. The charger housing 555-a and the charger housing 555-b (e.g., outer housing) may be manufactured for different sizes of wearable device by changing the size of the charging post 515, and maintaining the size of the base 510.

The charger housing 555 may house or contain the various components of the charging device 505, including a charger assembly 520 (e.g., charger assembly 520-a, 520-b). The charger assembly 520 may include an inductive charging component 525 (e.g., inductive charging coils, charging coils, inductive coils), charging pads (e.g., conductive pads 530, contact charging pads), mechanical components 545, and compressible component 550. Additional components of the charging device 505 may include a circuit board 540 (e.g., a PCB), an electrical contact component 535, and one or more mechanical components 545. As will be described in further detail herein, the electrical contact component 535 extending from the circuit board 540 may contact at various locations on the conductive pads 530, such that multiple sizes of charging devices 505 are supported by the same charger assembly 520.

As shown by comparing the first charging device 505-a and the second charging device 505-b, the charger assembly 520-a and the charger assembly 520-b may be identical (e.g., same size, same components, etc.). In other words, according to some aspects of the present disclosure, a single-sized charger assembly 520 may be manufactured to be compatible with multiple different sized charging devices 505.

The inductive charging component 525-a, 525-b of the charger assembly 520-a, 520-b may be configured to wirelessly interface with another (e.g., additional) inductive charging component of the wearable device. The inductive charging component 525 may be located inside the charger housing 555, and interface with the inductive charging component of the wearable device through the charger housing 555. In particular, the inductive charging component 525-a, 525-b may be configured to wirelessly interface with a wearable ring device through a surface of the respective charging post 515.

The charger assembly 520-a, 520-b may further include one or more conductive pads 530-a, 530-b (e.g., conductive pads, conductive charging pads) electrically coupled with the inductive charging component 525-a, 525-b. In some examples, the circuit board 540 may be a PCB. The conductive pads 530-a, 530-b may be located on a bottom side of the charger assembly 520-a, 520-b facing the circuit board 540-a, 540-b, as further shown and described in FIG. 6.

In some aspects, the circuit board 540-a, 540-b of the respective charging device 505-a, 505-b may be configured to electrically couple the charger assembly 520 to an external power source. The circuit board 540 (e.g., circuit board 540-a, circuit board 540-b) may include an electrical contact component 535-a, 535-b that is configured to electrically and physically contact the one or more conductive pads 530-a, 530-b of the charger assembly 520-a, 520-b at one of multiple locations along a length of the conductive pads 530 based on the size of the charging device 505. In particular, by comparing the first charging device 505-a and the second charging device 505-b, it may be seen that the location/position of the circuit board 540-a, 540-b (and therefore the location/position of the electrical contact components 535-a, 535-b) may remain unchanged for varying sized charging devices 505. Comparatively, the location/position of the charger assembly 520-a, 520-b within the charger housing 555-a, 555-b may change based on the size of the charging device 505. As such, the electrical contact components 535-a, 535-b of the circuit board 540-a, 540-b may contact the conductive pads 530-a, 530-b at varying locations depending on the size of the charging device 505-a, 505-b (and therefore based on the location of the charger assembly 520-a, 520-b within the charger housing 555-a, 555-b).

For example, the first charging device 505-a may have a smaller charging post 515-a for a smaller size of wearable device, whereas the second charging device 505-b may have a larger charging post 515-b for a larger size of wearable device. In this regard, due to the smaller charging post 515-a in the first charging device 505-a, the charger assembly 520-a may be moved further to the left relative to the circuit board 540-a. Comparatively, due to the larger charging post 515-b in the second charging device 505-a, the charger assembly 520-b may be moved further to the right relative to the circuit board 540-b. Further, as noted previously herein, the location/position of the circuit boards 540-a, 540-b within the charger housings 555-a, 555-b (and therefore the location/position of the electrical contact components 535-a, 535-b) is the same for both charging devices 505-a, 505-b.

Accordingly, in the first charging device 505-a, the electrical contact component 535-a may contact the conductive pads 530-a further to the right of the conductive pads 530-a of the charger assembly 520-a. Comparatively, in the second charging device 505-b, the electrical contact component 535-b may contact the conductive pads 530-b further to the left of the conductive pads 530-b of the charger assembly 520-b.

In this regard, different sizes of charging devices 505 have different points of contact between the conductive pads 530 and the electrical contact component 535, while the size of the charger assembly 520 remain constant. That is, the charger assembly 520-a and the charger assembly 520-b may be the same size, where the location/position of the charger assembly 520 (and therefore the point of contact between the conductive pads 530 and electrical contact component) changes based on the size of the charging device 505.

By enabling a single-sized charger assembly 520 to be compatible with multiple sized charging devices 505-a, 505-b, aspects of the present disclosure may reduce the discrete quantity of components used to manufacture charging devices 505-a, 505-b, thereby reducing the overall cost of a wearable device. Moreover, the use of “conductive pads 530” of the charger assembly 520 may greatly simplify the process of coupling the circuit board 540 to the inductive charging component 525. In particular, for some wearable charging devices, the inductive charging component 525 may have to be manually coupled to the circuit board 540, such as via wires or soldering. Comparatively, as shown in FIG. 5, the insertion of the charging post 515 and/or the charger assembly 520 into the charger housing 555/base 510 may result in automatic connection between the inductive charging component 525 and the circuit board 540 via the conductive pads 530, thereby simplifying the manufacturing process of the charging device 505.

To facilitate charging, the circuit board 540 may include a battery or may otherwise be connected to an external power source (e.g., electrical outlet). As such, energy may be transferred from the battery or external energy source through the circuit board 540, through the electrical contact component 535 to the conductive pads 530, and from the conductive pads to the inductive charging component 525, where the inductive charging component 525 is configured to wirelessly transfer energy through the surface of the charging post 515 to an additional inductive charging component of the wearable device.

The compressible component 550-a, 550-b of the charger assembly 520-a, 520-b may be made of a compressible material (e.g., foam) that is configured to exert a force that pushes the inductive charging component 525-a, 525-b against the surface of the charger housing 555-a (e.g., against an inner surface of the charging post 515-a, 515-b). In some cases, the inductive charging component 525-a, 525-b may be relatively planar, where the force exerted by the compressible component 550-a, 550-b causes the inductive charging component 525-a, 525-b to conform to a curvature/circumference of the charging post 515-a, 515-b. As such, the compressible component 550 may improve contact between the inductive charging component 525 and the surface of the charging post 515, thereby reducing a distance between the inductive charging component 525 of the charging device 505 and an inductive charging component of a wearable device to facilitate charging. That is, the compressible component 550 may be configured to reduce a size of any gaps between the inductive charging component 625 and a surface of the charger housing 555.

The charger assembly 520-a, 520-b may include one or more mechanical components 545-a, 545-b that are configured to engage with one or more other components of the charging device 505-a, 505-b. In particular, the mechanical components 545 of the charger assembly 520 may be configured to maintain the charger assembly 520 within a defined position within the charger housing 555. The mechanical components 545 may include any mechanical components that secure the charger assembly 520 within or to the charger housing 555. For example, as shown in FIG. 5, the mechanical component(s) 545 of the charger assembly 520 may include a “clip” that is configured to exert a force against an inner wall or surface within the charging post 515 in order to “push” the inductive charging component 525 against the surface of the charging post 515 (e.g., hold the inductive charging component 525 and the compressible component 550 flush against the inside of the charger housing 555) and maintain the charger assembly 520 within the charging post 515. In such cases, the “clip” (e.g., mechanical components 545) may be made of a flexible material, or may otherwise be at least partially deformable.

The radius (e.g., diameter, circumference) of the charging post 515 may be based on the size of the wearable ring device, and a position of the charger assembly 520 within the charger housing 555 may be based on the radius of the charging post 515, as described herein. The inductive charging component 525 of the charger assembly 520 may be configured to wirelessly interface with the additional inductive charging component of the wearable ring device to charge the wearable device through a surface of the post 515.

In some aspects, the charging device 505 may include a magnetic component, such as part of the charger housing 555. The magnetic component may be configured to magnetically interact with an additional magnetic component of the wearable device to orient the wearable device on or within the charging device 505 for charging. For example, the charging device 505 may include a magnetic component within the charging post 515 that interacts with an additional magnetic component within the wearable device to help orient the wearable device on the charging post 515 for charging.

FIG. 6 shows an example of a charging device diagram 600 that supports a wearable device charger in accordance with aspects of the present disclosure. The charging device diagram 600 may implement, or be implemented by, aspects of the system 100, system 200, charging device diagram 300, the charging device diagram 400, the charging device diagram 500, or any combination thereof. The charging device diagram 600 depicts cross-sections of a charging device 605-a and a charging device 605-b, which may be examples of the charging device 405-a and the charging device 405-b described with reference to FIG. 4, respectively. Similarly, the charging device 605-a and the charging device 605-b illustrated in FIG. 6 may include examples of the charging device 505-a and the charging device 505-b. In this regard, the first charging device 605-a may correspond to a smaller size or range of sizes of wearable device (e.g., ring size 6, ring sizes 6-8, etc.), and the second charging device 605-b may correspond to a larger size or range of sizes of wearable device (e.g., ring size 10, ring sizes 10-12, etc.). In some examples, the ranges of sizes of wearable device corresponding to the charging device 505-a and the charging device 505-b may overlap (e.g., ring sizes 6-8 and ring sizes 8-10).

The respective components of the charging devices 605 (e.g., charger assembly 620, inductive charging component 625, conductive pads 630, electrical contact component 635, circuit board 640, mechanical components 645, compressible component 650, charger housing 655) may be examples of the respective corresponding component as described with reference to FIG. 5.

As described previously herein, the position/location of the circuit board 640 and electrical contact component 635 may remain the same regardless of the size of the charging device 605. Comparatively, the size of the charging post 610 may change based on the size of the charging device 605 and, as a result, the position/location of the charger assembly 620 within the charger housing 655 may change based on the size of the charging device 605. As such, the position/location that the electrical contact component 635 contacts the conductive pads 630 may change based on the size of the charging device 605a. In other words, the electrical contact component 635 may couple to the one or more conductive pads 630 at different locations of the conductive pads 630, allowing for multiple sizes of charging devices to be manufactured using the same internal components.

For example, as shown in the first charging device 605-a for a smaller wearable device (e.g., U.S. ring size 6), the electrical contact component 635-a may contact the conductive pads 630-a toward the right side of the conductive pads 630-a. Comparatively, as shown in the second charging device 605-b for a larger wearable device (e.g., U.S. ring size 10), the electrical contact component 635-b may contact the conductive pads 630-b toward the left side of the conductive pads 630-b. As such, the inclusion of the conductive pads 630 may enable a single-sized charger assembly 620 to be used within charging devices 605 of varying size.

The circuit board 640 may be a PCB configured to electrically couple the charger assembly 620 to an external power source, such as a wall socket. The circuit board 640 may include an electrical contact component 635 configured to electrically and physically contact the conductive pads 630 at one of multiple locations along a length of the conductive pads 630 based on the charging device 605 size. The circuit board 640 may include additional components, such as one or more mechanical components (e.g., one or more of the mechanical components 645).

In some examples, the charger assembly 620 may be adjustably moved within the charger housing 655 in order to transition the charger size between multiple sizes of the charging device 605. In particular, in some cases, the size of the charging post 610 may be adjusted to accommodate varying ring sizes, where adjusting the size of the charging post 610 thereby modifies the location of the charger assembly 620 within the charging device 605 (and therefore modifies the location that the electrical contact component 635 contacts the conductive pads 630). In other words, the location that electrical contact component 635 contacts the conductive pads 630 may change across the length of the conductive pads 630 as the size of the charging device 605 is adjusted to accommodate different sized rings.

It should be noted that the methods described above describe possible implementations, and that the operations and the steps may be rearranged or otherwise modified and that other implementations are possible. Furthermore, aspects from two or more of the methods may be combined.

An apparatus for charging a wearable device is described. The apparatus may include a charger housing comprising a charger size that corresponds to a size of the wearable device, a charger assembly disposed within the charger housing, the charger assembly comprising an inductive charging component configured to wirelessly interface with an additional inductive charging component of the wearable device to charge the wearable device through the charger housing and one or more conductive pads electrically coupled with the inductive charging component, and a PCB configured to electrically couple the charger assembly to an external power source, the PCB comprising an electrical contact component configured to electrically and physically contact the one or more conductive pads at one of a plurality of locations along a length of the one or more conductive pads based at least in part on the charger size.

In some examples of the apparatus, the electrical contact component of the PCB contacts the one or more conductive pads at a first location along the length of the one or more conductive pads based at least in part on the charger housing comprising a first charger size, and the electrical contact component of the PCB contacts the one or more conductive pads at a second location along the length of the one or more conductive pads based at least in part on the charger housing comprising a second charger size that may be different from the first charger size.

In some examples of the apparatus, a position of the PCB within the charger housing remains constant regardless of the charger size and a position of the charger assembly within the charger housing changes based at least in part on the charger size.

In some examples of the apparatus, the charger assembly further comprises a compressible material (e.g., compressible component) configured to exert a force that pushes the inductive charging component against a surface of the charger housing.

In some examples of the apparatus, the inductive charging component may be substantially planar and the force exerted by the compressible material causes the inductive charging component to curve and substantially conform to a curvature of the charger housing.

In some examples of the apparatus, the charger assembly further comprises one or more mechanical components configured to engage with one or more additional mechanical components of the charger housing to secure the charger assembly within the charger housing.

In some examples of the apparatus, the charger assembly comprises a single assembly size that may be couplable to a plurality of charging devices exhibiting a plurality of charger sizes including the charger size.

In some examples of the apparatus, a position of the charger assembly within the charger housing may be based at least in part on the charger size and the charger assembly may be configured to be adjustably moved within the charger housing in order to transition the charger size between a plurality of charger sizes.

In some examples of the apparatus, the location that the electrical contact component contacts the one or more conductive pads changes across the plurality of locations along the length of the one or more conductive pads as the charger assembly may be adjustably moved within the charger housing.

In some examples of the apparatus, the charger housing 655 comprises a charger base, wherein the PCB may be positioned within the charger base and a charger post extending from the charger base, wherein the wearable ring device may be configured to at least partially surround the charger post when being charged by the charging device, and wherein the charger assembly may be positioned at least partially within the charger post.

In some examples of the apparatus, a radius of the charger post may be based at least in part on the size of the wearable ring device and a position of the charger assembly within the charger housing may be based at least in part on the radius of the charger post.

In some examples of the apparatus, the inductive charging component of the charger assembly may be configured to wirelessly interface with the additional inductive charging component of the wearable ring device to charge the wearable device through a surface of the charger post.

Some examples of the apparatus may further include a magnetic component configured to magnetically interact with an additional magnetic component of the wearable device to orient the wearable device on or within the charging device for charging. In some examples of the apparatus, the external power source comprises a battery, an electrical outlet, or both.

Another apparatus assembly for charger housings associated with a plurality of charger sizes is described. The apparatus may include one or more mechanical components configured to engage with one or more additional mechanical components of a charger housing of a charging device to secure the charger assembly within the charger housing, wherein a position of the charger assembly within the charger housing is based at least in part on a charger size of the charger housing, wherein the charger size corresponds to a size of a wearable device, an inductive charging component configured to wirelessly interface with an additional inductive charging component of the wearable device to charge the wearable device through the charger housing, and one or more conductive pads configured to electrically couple the inductive charging component with a PCB of the charging device and an external power source, wherein the one or more conductive pads contact an electrical contact component of the PCB at one of a plurality of locations along a length of the one or more conductive pads based at least in part on the charger size.

In some examples of the apparatus, wherein the one or more conductive pads contact the electrical contact component of the PCB at a first location along the length of the one or more conductive pads based at least in part on the charger housing comprising a first charger size and wherein the one or more conductive pads contact the electrical contact component of the PCB at a second location along the length of the one or more conductive pads based at least in part on the charger housing comprising a second charger size that may be different from the first charger size.

In some examples of the apparatus, a position of the PCB within the charger housing remains constant regardless of the charger size and a position of the charger assembly within the charger housing changes based at least in part on the charger size.

Some examples of the apparatus may further include a compressible material configured to exert a force that pushes the inductive charging component against a surface of the charger housing.

In some examples of the apparatus, the inductive charging component may be substantially planar and the force exerted by the compressible material causes the inductive charging component to curve and substantially conform to a curvature of the charger housing.

Some examples of the apparatus may further include a magnetic component configured to magnetically interact with an additional magnetic component of the wearable device to orient the wearable device on or within the charging device for charging.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A charging device for charging a wearable device, comprising:
a charger housing comprising a charger size that corresponds to a size of the wearable device;
a charger assembly disposed within the charger housing, the charger assembly comprising:
an inductive charging component configured to wirelessly interface with an additional inductive charging component of the wearable device to charge the wearable device through the charger housing; and
one or more conductive pads electrically coupled with the inductive charging component; and
a printed circuit board configured to electrically couple the charger assembly to an external power source, the printed circuit board comprising an electrical contact component configured to electrically and physically contact the one or more conductive pads at one of a plurality of locations along a length of the one or more conductive pads based at least in part on the charger size.

2. The charging device of claim 1,
wherein the electrical contact component of the printed circuit board contacts the one or more conductive pads at a first location along the length of the one or more conductive pads based at least in part on the charger housing comprising a first charger size, and
wherein the electrical contact component of the printed circuit board contacts the one or more conductive pads at a second location along the length of the one or more conductive pads based at least in part on the charger housing comprising a second charger size that is different from the first charger size.

3. The charging device of claim 1, wherein a position of the printed circuit board within the charger housing remains constant regardless of the charger size, and wherein a position of the charger assembly within the charger housing changes based at least in part on the charger size.

4. The charging device of claim 1, wherein the charger assembly further comprises:
a compressible material configured to exert a force that pushes the inductive charging component against a surface of the charger housing.

5. The charging device of claim 4, wherein the inductive charging component is substantially planar, and wherein the force exerted by the compressible material causes the inductive charging component to curve and substantially conform to a curvature of the charger housing.

6. The charging device of claim 1, wherein the charger assembly further comprises:
one or more mechanical components configured to engage with one or more additional mechanical components of the charger housing to secure the charger assembly within the charger housing.

7. The charging device of claim 1, wherein the charger assembly comprises a single assembly size that is couplable to a plurality of charging devices exhibiting a plurality of charger sizes including the charger size.

8. The charging device of claim 1, wherein a position of the charger assembly within the charger housing is based at least in part on the charger size, and wherein the charger assembly is configured to be adjustably moved within the charger housing in order to transition the charger size between a plurality of charger sizes.

9. The charging device of claim 8, wherein a location that the electrical contact component contacts the one or more conductive pads changes across the plurality of locations along the length of the one or more conductive pads as the charger assembly is adjustably moved within the charger housing.

10. The charging device of claim 1, wherein the wearable device comprises a wearable ring device, and wherein the charger housing comprises:
a charger base, wherein the printed circuit board is positioned within the charger base; and
a charger post extending from the charger base, wherein the wearable ring device is configured to at least partially surround the charger post when being charged by the charging device, and wherein the charger assembly is positioned at least partially within the charger post.

11. The charging device of claim 10, wherein a radius of the charger post is based at least in part on the size of the wearable ring device, and wherein a position of the charger assembly within the charger housing is based at least in part on the radius of the charger post.

12. The charging device of claim 10, wherein the inductive charging component of the charger assembly is configured to wirelessly interface with the additional inductive charging component of the wearable ring device to charge the wearable device through a surface of the charger post.

13. The charging device of claim 1, further comprising:
a magnetic component configured to magnetically interact with an additional magnetic component of the wearable device to orient the wearable device on or within the charging device for charging.

14. The charging device of claim 1, wherein the external power source comprises a battery, an electrical outlet, or both.

15. A charger assembly for charger housings associated with a plurality of charger sizes, comprising:
one or more mechanical components configured to engage with one or more additional mechanical components of a charger housing of a charging device to secure the charger assembly within the charger housing, wherein a position of the charger assembly within the charger housing is based at least in part on a charger size of the charger housing, wherein the charger size corresponds to a size of a wearable device;
an inductive charging component configured to wirelessly interface with an additional inductive charging component of the wearable device to charge the wearable device through the charger housing; and
one or more conductive pads configured to electrically couple the inductive charging component with a printed circuit board of the charging device and an external power source, wherein the one or more conductive pads contact an electrical contact component of the printed circuit board at one of a plurality of locations along a length of the one or more conductive pads based at least in part on the charger size.

16. The charger assembly of claim 15,
wherein the one or more conductive pads contact the electrical contact component of the printed circuit board at a first location along the length of the one or more conductive pads based at least in part on the charger housing comprising a first charger size, and
wherein the one or more conductive pads contact the electrical contact component of the printed circuit board at a second location along the length of the one or more conductive pads based at least in part on the charger housing comprising a second charger size that is different from the first charger size.

17. The charger assembly of claim 15, wherein a position of the printed circuit board within the charger housing remains constant regardless of the charger size, and wherein a position of the charger assembly within the charger housing changes based at least in part on the charger size.

18. The charger assembly of claim 15, further comprising:
a compressible material configured to exert a force that pushes the inductive charging component against a surface of the charger housing.

19. The charger assembly of claim 18, wherein the inductive charging component is substantially planar, and wherein the force exerted by the compressible material causes the inductive charging component to curve and substantially conform to a curvature of the charger housing.

20. The charger assembly of claim 15, further comprising:
a magnetic component configured to magnetically interact with an additional magnetic component of the wearable device to orient the wearable device on or within the charging device for charging.
